(19) United States
(12) Patent Application Publication
(10) Pub. No.: US 2010/0072017 A1
(43) Pub. Date: Mar. 25, 2010

(54) RELEASEABLE ONE-WAY CLUTCH

(75) Inventors: Mark A. Joki, Dover, OH (US); Donald J. Remboski, Akron, OH (US)

Correspondence Address: MICHAEL BEST & FRIEDRICH LLP, 100 E WISCONSIN AVENUE, Suite 3300, MILWAUKEE, WI, 53202, US

(73) Assignee: THE TIMKEN COMPANY, Canton, OH (US)

(21) Appl. No.: 12/447,514

(22) PCT Filed: Jan. 9, 2008
(86) PCT No.: PCT/US08/50631

§ 371 Date: Apr. 28, 2009

Related U.S. Application Data
(60) Provisional application No. 60/884,912, filed on Jan. 15, 2007.

(51) Int. Cl. F16D 41/06

(52) U.S. Cl. 192/44

(57) ABSTRACT

A clutch (22) includes a first member (48) rotatable with respect to a base member (14) in a first direction A and a second direction B, a second member (56) rotatable with respect to the base member, a rolling element (62) between the first and second members, and a ramp sleeve (58) disposed between the first and second members, and coupled to the base member such that the ramp sleeve is generally prevented from rotating with respect to the base member. The ramp sleeve includes a ramp (82). The second member includes a first rotational position with respect to the ramp sleeve and a second rotational position with respect to the ramp sleeve. The rolling element is configured to wedge against the ramp to prevent relative rotation of the first member with respect to the base member in the first direction when the second member is in the first rotational position. When the second member is in the second rotational position, the first member is able to rotate with respect to the base member in the first rotational direction.

### RELATED APPLICATIONS

This application claims priority to U.S. Provisional Patent Application Ser. No. 60/884,912 filed on Jan. 15, 2007, the entire content of which is incorporated herein by reference.

### BACKGROUND

The present invention relates to one-way clutches.

One-way clutches are often used for holding a load in applications such as vehicle parking brakes. One known one-way clutch utilized in parking brakes includes a pawl and ratchet such that the pawl engages teeth on the ratchet to hold the parking brake in a loaded or locked position.

### SUMMARY

One-way clutches that utilize ratchets can be undesirable is some applications because the pawl and ratchet include discrete holding steps that are defined by the number of teeth of the ratchet. In addition, the pawl and ratchet can create undesirable noise as the pawl travels along the teeth of the ratchet. The one-way clutch of the present invention includes generally infinite holding positions and can be quieter than a pawl and ratchet.

The present invention provides, in one aspect, a clutch configured to be coupled to a base member. The clutch includes a first member rotatable with respect to the base member in a first direction and a second direction, a second member rotatable with respect to the base member, a rolling element between the first and second members, and a ramp sleeve disposed between the first and second members and coupled to the base member such that the ramp sleeve is generally prevented from rotating with respect to the base member. The ramp sleeve includes a ramp. The second member includes a first rotational position with respect to the ramp sleeve and a second rotational position with respect to the ramp sleeve. The rolling element is configured to wedge against the ramp to prevent relative rotation of the first member with respect to the base member in the first direction when the second member is in the first rotational position. When the second member is in the second rotational position, the first member is able to rotate with respect to the base member in the first rotational direction.

### BRIEF DESCRIPTION OF THE DRAWINGS

FIG. 1 is a perspective view of a parking brake that includes a clutch embodying the present invention.

FIG. 2 is a partial cross-sectional view of the parking brake of FIG. 1

FIG. 3 is cross-sectional view of a clutch utilized in the parking brake of FIG. 1.

FIG. 4 is an enlarged view of a portion of FIG. 3.

FIG. 5 is a cross-sectional view illustrating the interaction between a ramp sleeve of the clutch of FIG. 3 and a stationary bracket of the parking brake of FIG. 1.

FIG. 6 is an enlarged, cross-sectional view of an alternative construction of a clutch utilized in the parking brake of FIG. 1.

FIG. 7 is an enlarged, cross-sectional view of another alternative construction of a clutch utilized in the parking brake of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The present invention will be described with reference to the accompanying drawing figures wherein like numbers represent like elements throughout. Certain terminology, for example, “inner”, “outer”, “clockwise”, and “counterclockwise” is used in the following description for relative descriptive clarity only and is not intended to be limiting.

### DETAILED DESCRIPTION

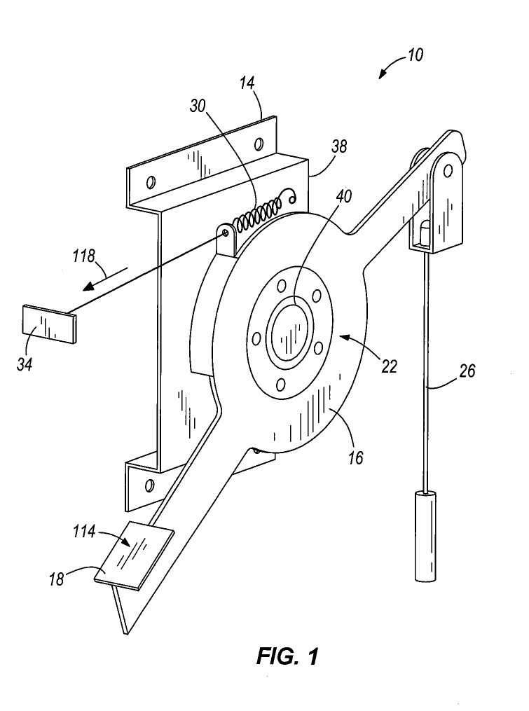

FIG. 1 illustrates a parking brake pedal assembly 10. The parking brake pedal assembly 10 includes a stationary base or bracket 14 that is fixed to a vehicle and a pivoting bracket 16 that pivots with respect to the stationary bracket 14. The bracket 16 includes a pedal 18 that it utilized by a user to actuate the parking brake pedal assembly 10. When the user presses on the pedal 18, typically with their foot, a clutch 22 of the parking brake pedal assembly 10 facilitates pivoting of the bracket 16 with respect to the bracket 14 to place tension in a cable 26. After the user places tension in the cable 26, the clutch 22 holds tension in the cable 26, discussed in more detail below. As would be understood by one of skill in the art, when tension is applied to the cable 26, a brake of the vehicle is engaged. As will be discussed in more detail below, the parking brake pedal assembly 10 further includes a spring 30 that prevents unwanted release of the tension in the cable 26 and a release handle 34 that can be pulled by the user to release the tension in the cable 26.

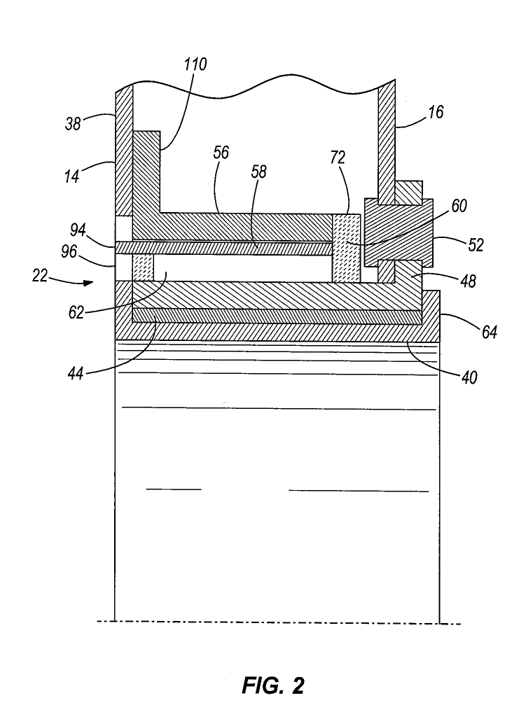

Referring to FIGS. 1 and 2, the stationary bracket 14 includes a base portion 38 and a cylindrical portion 40 that extends from the base portion 38. A bearing 44 is disposed around the cylindrical portion 40 to support the bracket 16. The bearing 44 can be any suitable bearing, such as a plastic friction bearing, a bushing, a sleeve bearing, and the like.

Referring to FIG. 2, the clutch 22 includes an inner ring 48 that is coupled for rotation with the pivoting bracket 16. In the illustrated construction, the inner ring 48 is coupled to the pivoting bracket 16 using a rivet 52. In other constructions, the inner ring 48 can be coupled to the pivoting bracket 16 using other fasteners, by welding, and the like. In yet other constructions, the inner ring 48 can be integrally formed with the pivoting bracket 16.

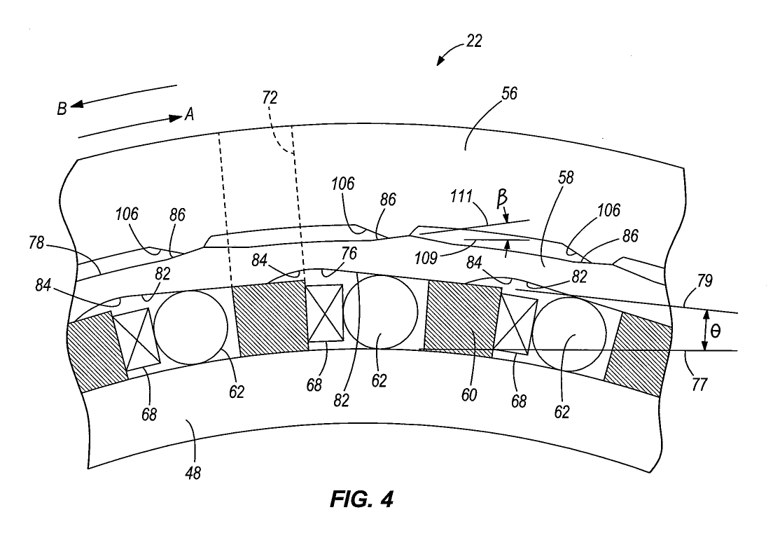

Referring to FIGS. 2 and 4, the clutch 22 further includes an outer ring 56, a ramp sleeve 58, a cage 60, and a plurality of rolling elements 62 (e.g., rollers). Fold-over tangs 64 (FIG. 2) of the bracket 14 facilitate holding the clutch 22 together.

The illustrated rolling elements 62 are cylindrical rollers that roll along the inner ring 48 and the ramp sleeve 58. While the rolling elements 62 are cylindrical rolling elements in the illustrated construction, in other constructions, the rolling elements can include ball rolling elements.

The rolling elements 62 are spaced by the cage 60, and the cage 60 is located at least partially between the inner ring 48 and the ramp sleeve 58. The cage 60 includes springs 68 that bias corresponding rolling elements 62 in the direction of arrow A of FIG. 4. The cage 60 further includes a radially extending portion 72 (FIG. 2) that engages the outer ring 56 such that the cage 60 and the outer ring 56 are coupled for rotation. Furthermore, the cage 60 maintains the ramp sleeve 58 generally concentric with the inner ring 48.

Referring to FIG. 4, the ramp sleeve 58 defines an inner surface 76 and an outer surface 78. Ramp portions 82 are formed on the inner surface 76 of the ramp sleeve 58, each ramp portion 82 receiving a respective rolling element 62. The ramp portions 82 are formed such that the inner surface 76 of the ramp sleeve 58 contacts the rolling elements 62 at a shallow contact angle θ between a first line 77 tangent to the inner ring 48 at the point of contact with the rolling element 62 and a second line 79 parallel with the ramp portion 82 of the inner surface 78. In the illustrated construction, the angle θ is about 5 degrees. Alternatively, the angle θ may be between about 2 degrees and about 8 degrees. A recess 84 is formed in the ramp sleeve 58 at an end of each of the ramp portions 82.

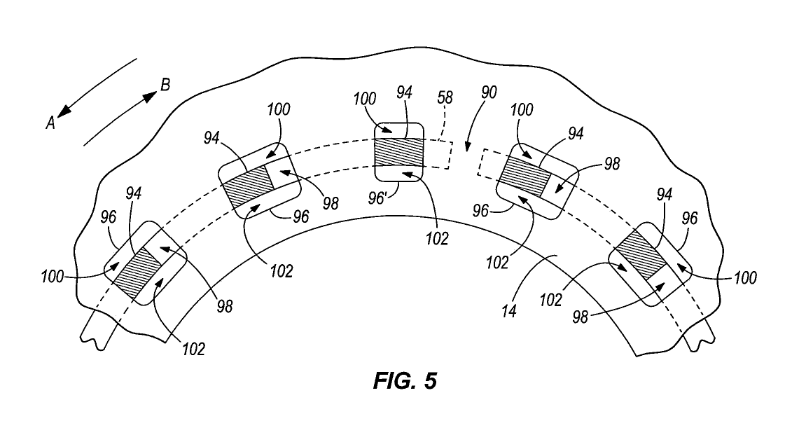

With continued reference to FIG. 4, tapered projections 86 extend from the outer surface 78 of the ramp sleeve 58, the purpose of which will be discussed in more detail below. Referring to FIG. 5, the ramp sleeve 58 further includes a slit or slot 90 such that the ramp sleeve 58 forms a non-continuous cylinder. The slot 90 facilitates expansion and contraction of the ramp sleeve 58. The ramp sleeve 58 is keyed to the stationary bracket 14 using tabs 94 of the ramp sleeve 58 that are received in respective openings or windows 96 formed in the stationary bracket 14.

As best seen in FIG. 5, one of the windows, labeled 96′, adjacent the slot 90 is sized approximately the same in the circumferential direction as the outer dimension of the tab 94. Thus, there is substantially no circumferential gap between the tab 94 located in window 96′ and the bracket 14. In other words, the circumferential length of the window 96′ is about equal to the circumferential length of its associated tab 94. Therefore, the ramp sleeve 58 is substantially fixed from rotating with respect to the stationary bracket 14. The remaining windows 96 are sized such that there is a gap 98 in the circumferential direction between the bracket 14 and the tab 94. In other words, the circumferential length of the windows 96 is greater than the circumferential length of the tabs 94. Furthermore, all of the windows 96 and 96′ are sized such that there are gaps 100, 102 in the radial directions between the tabs 94 and the bracket 14. In other words, the radial height of the windows 96 and 96′ is greater than the radial thickness of the tabs 94. Therefore, because of the slot 90, the ramp sleeve 58 can expand from the position illustrated in FIG. 5. As the ramp sleeve 58 expands from the position illustrated in FIG. 5, the tab 94 located in the window 96′ holds the ramp sleeve 58 from moving in circumferential directions (the direction of arrows A and B). However, because of the radial gaps 100, the ramp sleeve 58 is able to expand and the circumferential gaps 98 facilitate growth in the direction of arrow B. Furthermore, because there is substantially no circumferential gap between the tabs 94 and the windows 96 on the sides of the tabs 94 opposite the gaps 98, the ramp sleeve 58 is able to transmit torque in the direction of arrow A, which is counterclockwise in FIG. 5 and clockwise in FIG. 4.

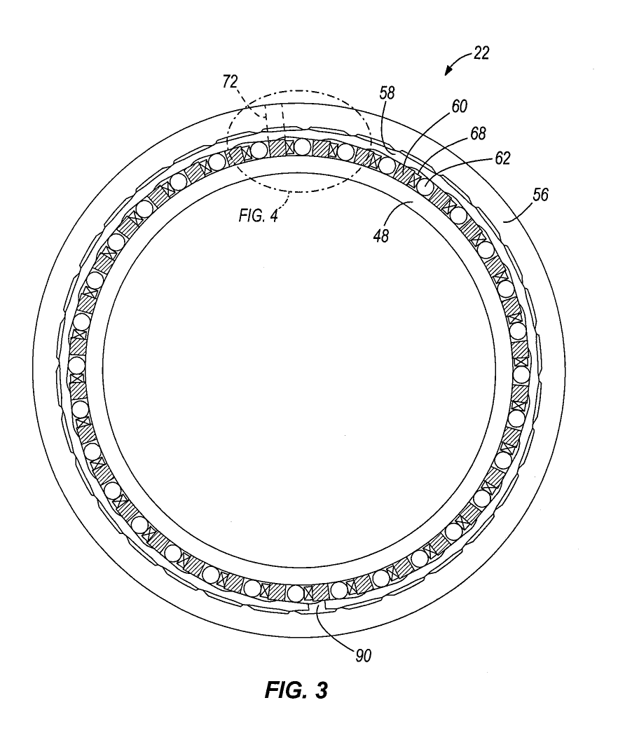

Referring to FIGS. 3 and 4, the outer ring 56 surrounds the ramp sleeve 58 and the outer ring 56 includes tapered projections 106 that correspond to the tapered projections 86 of the ramp sleeve 58. With reference to FIG. 4, the mating surfaces of each pair of projections 86, 106 define a contact angle β between a first line 109 parallel with the line 77 and a second line 111 parallel with the mating surfaces of the projections 86, 106. The contact angle β may be between about 8 degrees and about 12 degrees. Preferably, the contact angle β is about 10 degrees. As best seen in FIG. 2, the outer ring 56 further includes a flange or protrusion 110 that extends radially from the outer ring 56. The flange 110 is utilized to couple the release handle 34 and the spring 30 (see FIG. 1) to the outer ring 56. As will be discussed in more detail below, the spring 30 rotationally biases the outer ring 56 and the release handle 34 allows the user to rotate the outer ring 56 against the bias of the spring 30.

Referring to FIGS. 1 and 4, in operation, the spring 30 applies a tangential load or bias to the outer ring 56 through the flange 110 (FIG. 2) such that the outer ring 56 is rotationally biased in the clockwise direction or in the direction of arrow A of FIG. 4.

Referring to FIG. 4, the rotational bias of the outer ring 56 in the clockwise direction holds the tapered projections 106 of the outer ring 56 against the ramp portions 86 of the ramp sleeve 58. The projections 86 and 106 are tapered such that the outer ring 56 biases the ramp sleeve 58 radially inward. As discussed above and as illustrated in FIG. 5, the ramp sleeve 58 is keyed to the stationary bracket 14 to permit expansion and contraction in the radial directions while limiting rotation of ramp sleeve 58 in the clockwise and counterclockwise directions. Meanwhile, the springs 68 of the cage 60, which is fixed for rotation with the outer ring 56, bias corresponding rolling elements 62 in the clockwise direction of FIG. 4 (direction of arrow A).

Referring to FIG. 1, the user presses on the pedal 18, generally in the direction of arrow 114, to rotate the pivoting bracket 16 with relatively little resistance to place tension in the cable 26, and thus activate the parking brake. Referring to FIG. 2, rotation of the pivoting bracket 16, which is coupled to the inner ring 48, causes a corresponding rotation of the inner ring 48. Referring to FIG. 4, in the illustrated construction, when the user presses the pedal 18 (FIG. 1) the inner ring 48 rotates in counterclockwise direction (direction of arrow B).

Referring to FIG. 4, when inner ring 48 rotates in the counterclockwise direction, the rolling elements 62 roll in the counterclockwise direction toward the corresponding recess 84 against the bias of the spring 68 of the cage 60. Meanwhile, the outer ring 56 remains generally fixed and because the cage 60 is coupled to the outer ring 56 through the radially extending portion 72, the cage 60 also remains generally fixed. Also, as illustrated in FIG. 5, the ramp sleeve 58 generally does not rotate because the tab 94 is received in the window 96′.

Referring to FIG. 1, after the user has placed tension in the cable 26, the user releases the pedal 18. Referring to FIGS. 1 and 4, when the user releases the pedal 18, the tension in the cable 26 tends to rotate the inner ring 48 in the direction of arrow A because the inner ring 48 is coupled to the pivoting bracket 16. However, when the pedal 18 is released, referring to FIG. 4, the rolling elements 62 roll slightly in the direction of arrow A until the rolling elements 62 are wedged into the shallow angle of the ramps 76 between the ramps 76 and the inner ring 48 to prevent rotation of the inner ring 48 in the direction of arrow A and therefore prevent loss of tension in the cable 26 of FIG. 1. Also, referring to FIG. 5, the ramp sleeve 58 has a tendency to rotate in the direction of arrow A because of the rotational bias on the inner ring 48 in the direction of arrow A and the roller elements 62 therebetween. However, because the tabs 94 contact the stationary bracket 14 in the direction of arrow A, the ramp sleeve 58 is able to transmit torque in the direction of arrow A to counteract the rotational bias from the inner ring 48 (FIG. 4). Meanwhile, referring to FIG. 4, the outer ring 56 is biased in the clockwise direction by the spring 30 of FIG. 1. Therefore, the ramp projections 106 of the outer ring 56 act against the ramp projections 86 of the ramp sleeve 58 to prevent the ramp sleeve 58 from radially expanding, thus preventing the inner ring 48 from rotating in the clockwise direction to allow tension to be released from the cable 26 of FIG. 1.

Referring to FIG. 1, when the handle 34 is pulled, generally in the direction of arrow 118, the spring 30 is compressed and, referring to FIG. 4, the outer ring 56 rotates in the direction of arrow B. With continued reference to FIG. 4, rotation of the outer ring 56 in the counterclockwise direction moves the ramp projections 106 of the outer ring 56 down the ramp projection 86 of the ramp sleeve 58, and when the outer ring 56 rotates, the cage 60 also rotates because the cage 60 is coupled for rotation with the outer ring 56 through the radially extending portion 72 of the cage 60. The tension in the cable 26 is sufficient to rotate the inner ring 48 in a clockwise direction from its orientation shown in FIG. 4, causing the rolling elements 62 to engage the respective ramp portions 82 and deflect the ramp sleeve 58 radially outwardly. As a result, the “wedge effect” imparted by the contact angle θ is substantially eliminated because the lines 77, 79 (see FIG. 4) become more parallel as the ramp sleeve 58 deflects radially outwardly. Further, the rolling elements 62 become unwedged or unlocked from between the ramp sleeve 58 and the inner ring 48 to allow the inner ring 48 to continue to rotate in the clockwise direction to relieve the tension in the cable 26 of FIG. 1. This arrangement therefore provides a clutch 22 with the ability to release under the load from the tension in the cable 26.

Referring to FIG. 1, when the handle 34 is released, the clutch 22 resets back to the position illustrated in FIG. 4 and there is relatively little or no tension in the cable 26.

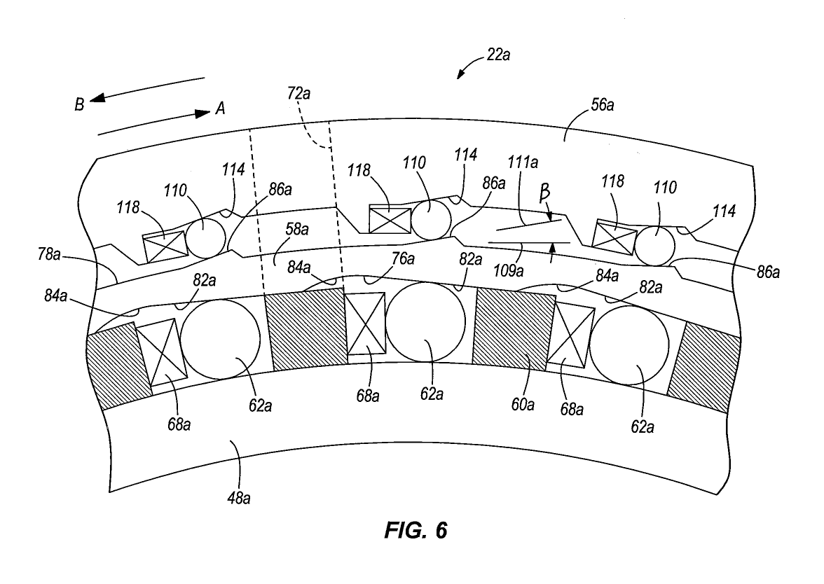

FIG. 6 illustrates an alternative construction of a clutch 22a utilized in the parking brake pedal assembly 10 of FIG. 1. Like components are labeled with like reference numerals, with the letter “a” added. The clutch 22a is substantially similar to the clutch 22 of FIGS. 2-5, however, the clutch 22a includes a plurality of rolling elements 110 between the ramp sleeve 58a and the outer ring 56a to facilitate rotation of the outer ring 56a relative to the ramp sleeve 58a. As shown in FIG. 6, a plurality of ramps or projections 86a are formed on the outer periphery of the ramp sleeve 58a, and a plurality of recesses 114 are formed in the inner periphery of the outer ring 56a. With reference to FIG. 6, the contact angle β is also defined between a first horizontal line 109a and a second line 111a parallel with the outer surface of the projection 86a. The contact angle β may be between about 8 degrees and about 12 degrees. Preferably, the contact angle β is about 10 degrees. The clutch 22a also includes a plurality of springs 118 positioned between the ramp sleeve 58a and the outer ring 56a. Each of the springs 118 is configured to bias a rolling element 110 against an associated projection 86a.

When the rolling elements 110 are situated with respect to the ramp sleeve 58a and outer ring 56a as shown in FIG. 6, the ramp sleeve 58a is prevented from expanding radially outwardly to allow the inner ring 48a to slip or rotate relative to the ramp sleeve 58a and the stationary bracket 14. However, when the outer ring 56a is rotated in a counterclockwise direction relative to the ramp sleeve 58a from its orientation shown in FIG. 6 (i.e., when the release handle 34 is pulled), the rolling elements 110 are at least partially disengaged from the projections 86a and at least partially displaced or moved into the recesses 114 in the outer ring 56a. This allows the ramp sleeve 58a, in a manner similar to that described above, to expand or deflect radially outwardly to allow the inner ring 48a to rotate relative to the ramp sleeve 58a and stationary bracket 16 to relieve the tension in the cable 26 to release the parking brake.

Rather than incorporating the rolling elements 110 between the outer ring 56 and the ramp sleeve 58, the clutch 22 may alternatively utilize a friction-reducing coating on the contacting surfaces of the respective projections 86, 106 to facilitate rotation of the outer ring 56 relative to the ramp sleeve 58.

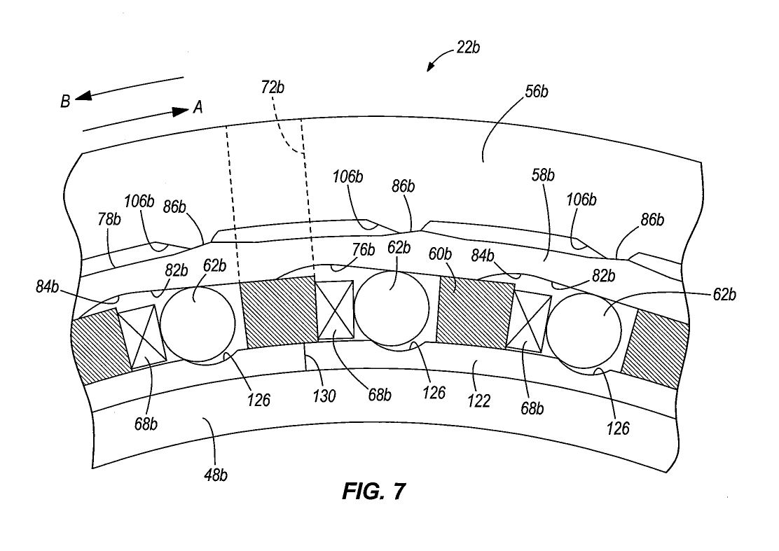

FIG. 7 illustrates another alternative construction of a clutch 22b utilized in the parking brake pedal assembly 10 of FIG. 1. Like components are labeled with like reference numerals, with the letter “b” added. The clutch 22b is substantially similar to the clutch 22 of FIGS. 2-5, however, the clutch 22b includes a slipper 122 positioned between the rolling elements 62b and the inner ring 48b. As shown in FIG. 7, the slipper 122 includes a plurality of arcuate or curved ramp surfaces 126, each of which supports a rolling element 62b. The slipper 122 also includes a radial slot 130 to facilitate expansion and contraction of the slipper 122.

When the slipper 122 is expanded, the frictional forces between the slipper 122 and the inner ring 48b are negligible such that the inner ring 48b is allowed to rotate relative to the slipper 122. When the slipper 122 is collapsed or contracted, the frictional forces between the slipper 122 and inner ring 48b are sufficiently high to lock the inner ring 48b to the slipper 122. Like the ramp sleeve 58b, the slipper 122 may include one or more tabs protruding through respective openings or windows in the base portion 38 of the stationary bracket 14 to limit or constrain the rotation of the slipper 122 relative to the inner ring 48b. Particularly, the rotation of the slipper 122 may be limited between the orientation of the slipper 122 shown in FIG. 7, in which the slipper 122 is collapsed onto the inner ring 48b to lock to the inner ring 48b, and a neutral orientation of the slipper 122, in which the rolling elements 62b are located in the bottom of the respective ramp surfaces 126 where the rolling elements 62b cannot wedge against the respective ramp portions 82b of the ramp sleeve 58b.

Initially, the operation of the clutch 22b is substantially similar to the operation of the clutch 22 of FIGS. 2-5. When the pedal 18 is released after applying the parking brake, the tension in the cable 26 causes the pivoting bracket 16, and therefore the inner ring 48b, to initially rotate in a clockwise direction. The frictional drag between the inner ring 48b and the slipper 122 causes the slipper 122 to index or rotate from its neutral orientation to the orientation shown in FIG. 7 because clockwise rotation of the slipper 122 is unconstrained by the tab and opening structure discussed above. Like the clutch 22 in FIGS. 2-5, the cage 60b remains stationary upon rotation of the inner ring 48b. As a result, the rolling elements 62b ride up the respective ramp surfaces 126 and wedge or jam against the ramp portions 82b of the ramp sleeve 58b, causing the slipper 122 to collapse on the inner ring 48b and lock to the inner ring 48b. Because the ramp sleeve 58b is rotationally constrained by the stationary bracket 14 and the slipper 122 is locked to the inner ring 48b, the clutch 22b assumes a locked configuration to maintain the tension in the cable 26 to apply the parking brake.

To unlock the clutch 22b, the outer ring 56b is rotated in a counterclockwise direction from the orientation of the outer ring 56b shown in FIG. 7, in a manner similar to the clutch 22 of FIGS. 2-5. For the same reason as discussed above, the “wedge effect” between the ramp sleeve 58b and the slipper 122 is lost, permitting the rolling elements 62b to disengage the ramp portions 82b and roll down the ramp surfaces 126 of the slipper 122. Consequently, the slipper 122 is allowed to expand and unlock from the inner ring 48b to permit the inner ring 48b and pivoting bracket 16 to rotate counterclockwise to relieve the tension in the cable 26 and release the parking brake.

While in the illustrated construction release of the clutch 22 is accomplished by rotation of the outer ring 56, in other constructions, the clutch can be configured such that release of the clutch is accomplished through rotation of the inner ring 48. In such constructions, what is illustrated and described as the outer ring 56 would form the inner ring, while what is illustrated and described as the inner ring 48 would form the outer ring.

Furthermore, while the clutch 22 was illustrated and described for use with a parking brake, the clutch 22 can be used in other suitable applications, such as applications that utilize a clutch that releases or unlocks while under an external load.

Various features and advantages of the invention are set forth in the following claims.

What is claimed is:

1. A clutch configured to be coupled to a base member, the clutch comprising:
a first member rotatable with respect to the base member in a first direction and a second direction;
a second member rotatable with respect to the base member;
a rolling element between the first and second members; and
a ramp sleeve disposed between the first and second members and coupled to the base member such that the ramp sleeve is generally prevented from rotating with respect to the base member, the ramp sleeve including a ramp,
wherein the second member includes a first rotational position with respect to the ramp sleeve and a second rotational position with respect to the ramp sleeve,
wherein the rolling element is configured to wedge against the ramp to prevent relative rotation of the first member with respect to the base member in the first direction when the second member is in the first rotational position, and
wherein when the second member is in the second rotational position, the first member is able to rotate with respect to the base member in the first rotational direction.

2. The clutch of claim 1, wherein the ramp sleeve includes a first projection, and wherein the second member includes a second projection engaged with the first projection when the second member is in the first rotational position to facilitate prevention of relative rotation of the first member with respect to the base member in the first direction.

3. The clutch of claim 2, wherein the first projection is on an outer periphery of the ramp sleeve, and wherein the second projection is on an inner periphery of the second member.

4. The clutch of claim 3, wherein the first projection is one of a plurality of projections on the outer periphery of the ramp sleeve, and wherein the second projection is one of a plurality of projections on the inner periphery of the second member.

5. The clutch of claim 2, wherein the second projection is disengaged from the first projection when the second member is in the second rotational position to facilitate relative rotation of the first member with respect to the base member in the first direction.

6. The clutch of claim 5, wherein the ramp sleeve includes a radial slot to facilitate expansion and contraction of the ramp sleeve, and wherein rotation of the first member in the first direction, when the second member is in the second rotational position, causes the rolling element to engage the ramp and expand the ramp sleeve to permit continued rotation of the first member in the first direction.

7. The clutch of claim 1, wherein the base member includes an opening, and wherein the ramp sleeve includes a tab extending at least partially into the opening to rotationally interconnect the ramp sleeve and the base member.

8. The clutch of claim 7, wherein the opening in the base member has a radial height greater than the radial thickness of the tab on the ramp sleeve.

9. The clutch of claim 1, wherein the base member includes a first opening and the ramp sleeve includes a first tab extending at least partially into the first opening, wherein the base member includes a second opening and the ramp sleeve includes a second tab extending at least partially into the second opening, wherein the first tab has a circumferential length substantially equal to a circumferential length of the first opening, and wherein the second tab has a circumferential length less than a circumferential length of the second opening.

10. The clutch of claim 1, wherein the rolling element is one of a plurality of rolling elements, wherein the clutch further includes a cage spacing the rolling elements about the periphery of the first member, and wherein the cage is coupled for rotation with the second member.

11. The clutch of claim 1, further comprising a spring biasing the rolling element against the ramp on the ramp sleeve.

12. The clutch of claim 11, further comprising a recess in the ramp sleeve, wherein the recess is positioned adjacent the ramp, and wherein the spring biases the rolling element away from the recess.

13. The clutch of claim 12, wherein the rolling element is disengaged from the ramp and displaced into the recess against the bias of the spring upon rotating the first member in the second direction with respect to the base member.

14. The clutch of claim 1, wherein the ramp defines a contact angle with the first member between a first line tangent to the first member at a point of contact with the rolling element and a second line substantially parallel with the ramp, and wherein the contact angle is between about 2 degrees and about 8 degrees.

15. The clutch of claim 1, wherein the first member includes a surface that defines a cylinder, and wherein the rolling element rolls along the surface of the first member.

16. The clutch of claim 1, wherein the first member includes a surface that defines a cylinder, wherein the clutch further includes a generally cylindrical slipper disposed between the surface of the first member and the rolling element, the slipper including a ramped face on which the rolling element rolls.

17. The clutch of claim 1, wherein the ramp sleeve includes one of a projection and a recess, wherein the second member includes the other of the projection and the recess, wherein the rolling element is a first rolling element, wherein the clutch further includes a second rolling element positioned between the ramp sleeve and the second member, and wherein the second rolling element is engaged with the projection and displaced from the recess when the second member is in the first rotational position to facilitate prevention of relative rotation of the first member with respect to the base member in the first direction.

18. The clutch of claim 17, wherein the second rolling element is at least partially disengaged from the projection and at least partially displaced into the recess when the second member is in the second rotational position to facilitate relative rotation of the first member with respect to the base member in the first direction.

19. The clutch of claim 17, further comprising a spring biasing the second rolling element against the projection.

20. The clutch of claim 17, wherein the ramp sleeve includes the projection on an outer periphery of the ramp sleeve, and wherein the second member includes the recess in an inner periphery of the second member.
